(19) United States
(12) Patent Application Publication
(10) Pub. No.: US 2026/0233368 A1
(43) Pub. Date: Aug. 13, 2026

(54) TORQUE TOOL WITH AUTOMATIC COMPENSATION VALUE CONVERSION

(71) Applicant: Shih-Hao LAI, Taichung City (TW)

(72) Inventor: Shih-Hao LAI, Taichung City (TW)

(21) Appl. No.: 19/052,418

(22) Filed: Feb. 13, 2025

(51) Int. Cl. B25B 23/142; G01L 25/00

(52) U.S. Cl. CPC B25B 23/1425; G01L 25/003

(57) ABSTRACT

A torque tool with automatic compensation value conversion includes a body with a driving head and a measurement device connected to the body. The measurement device features a control panel with a display, a mode button, and a setting button. The mode button switches the device to correction mode to display a measured torque value, while the setting button allows input of a standard torque value. The device calculates a first compensation ratio between 0.5 and 1.5 inclusive based on these values. In working mode, the device measures the torque of the driving head and displays a compensation torque value, calculated as the product of the measured torque value and the first compensation ratio.

### BACKGROUND OF THE INVENTION

The present invention relates to a torque tool and, more particularly, to a torque tool with automatic compensation value conversion.

Taiwan Patent No. TWM497080 discloses a torque tool calibration device, which comprises: a measured part plugged into an electronic torque tool, one end of which is inwardly concavely provided with a measuring slot, and the measuring slot is sleeved on the driving part of the electronic torque tool; a driving handle, one end of which is connected to the opposite end of the measured part where the measuring slot is provided, and a transmission unit signal is provided on the driving handle to connect to the electronic instrument panel of the electronic torque tool. A signal conversion unit and a comparison unit are disposed in the driving handle. The signal conversion unit converts the actual torque value between the electronic torque tool and the measured part and transmits it to the comparison unit. The comparison unit compares the converted actual torque value with the value of the electronic instrument panel of the electronic torque tool, and further calibrates the value in the electronic instrument panel of the electronic torque tool to match the actual torque value.

The requirement for digital torque wrenches to be returned to the manufacturer for maintenance or calibrated using specialized equipment arises because adjusting the calculation parameters of the measurement system in an electronic torque tool necessitates connecting the digital torque wrench to a computer or calibration device via a signal cable. This process is not feasible for general users or operators without access to calibration equipment.

### SUMMARY OF THE INVENTION

The invention provides a torque tool with automatic compensation value conversion, which includes a body having a driving head at one end thereof, and a measurement device connected to the body and configured to measure the torque of the driving head to obtain a measured torque value. The measurement device has a control panel including a display, a mode button, and a setting button. The mode button is configured to be pressed to switch the measurement device from a working mode to a correction mode and to display the measured torque value on the display. The setting button is configured to be pressed to enable the input of a standard torque value. The measurement device calculates a first compensation ratio based on the measured torque value and the standard torque value, and the first compensation ratio is between 0.5 and 1.5 inclusive. When the measurement device is in the working mode, the measurement device measures the torque of the driving head and displays a compensation torque value on the display, and the compensation torque value is the product of the measured torque value and the first compensation ratio.

The present invention will become clearer in light of the following detailed description of illustrative embodiments of this invention described in connection with the drawings.

### BRIEF DESCRIPTION OF DRAWINGS

FIG. 1 is a perspective view of a torque tool according to the present invention.

FIG. 2 is a top view of the torque tool in FIG. 1, showing a first parameter displayed on a display.

FIG. 3 is a top view of the torque tool in FIG. 1, showing a second parameter displayed on the display.

FIG. 4 to FIG. 7 are top views of the torque tool in FIG. 1, alternately showing the first parameter and the second parameter displayed on the display.

### DETAILED DESCRIPTION OF THE INVENTION

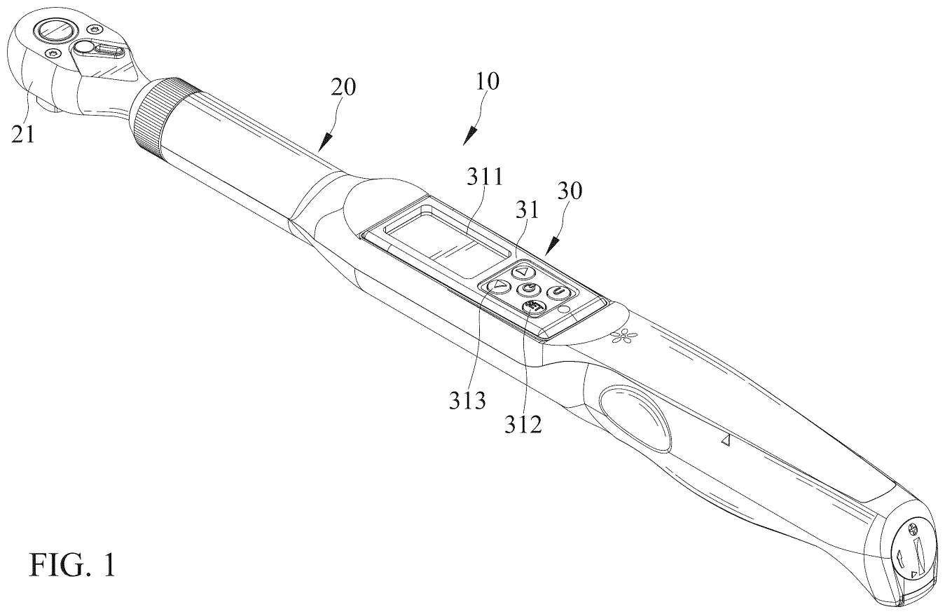

Referring to FIGS. 1 to 7, the present invention relates to a torque tool 10 with automatic compensation value conversion, illustrated in both perspective and top views. The torque tool 10 includes a body 20 and a measurement device 30.

One end of the body 20 is provided with a driving head 21.

The measurement device 30 is connected to the body 20 and is configured to measure the torque of the driving head 21 to obtain a measured torque value. The measurement device 30 has a control panel 31, which includes a display 311, a mode button 312, and a setting button 313. The mode button 312 is configured to be pressed to switch the measurement device 30 from a working mode to a correction mode and to display the measured torque value on the display 311, and the setting button 313 is configured to be pressed to enable the input of a standard torque value. The measurement device 30 calculates a first compensation ratio based on the measured torque value and the standard torque value, and the first compensation ratio is between 0.5 and 1.5 inclusive. When the measurement device 30 is in the working mode, the measurement device 30 measures the torque of the driving head 21 and displays a compensation torque value on the display 311, and the compensation torque value is the product of the measured torque value and the first compensation ratio.

The measurement device 30 is configured to set a limit torque value based on a rated upper limit torque value withstandable by the driving head 21. The measurement device 30 is further configured to set a first intermediate value greater than 0 and less than the limit torque value, and the measurement device 30 defines a first torque range and a second torque range based on the first intermediate value. The first torque range is greater than 0 and less than the first intermediate value, and the second torque range is greater than the first intermediate value and less than the limit torque value. When the measurement device 30 is in the correction mode and the standard torque value has been input, if the standard torque value is within the first torque range, the measurement device 30 obtains the first compensation ratio, and If the standard torque value is within the second torque range, the measurement device 30 calculates a second compensation ratio based on the measured torque value and the standard torque value, and the second compensation ratio is between 0.5 and 1.5 inclusive. When the measurement device 30 is in the working mode, if the measured torque value is within the first torque range, the compensation torque value displayed on the display 311 is the product of the measured torque value and the first compensation ratio, If the measured torque value is within the second torque range, the compensation torque value displayed on the display 311 is the product of the measured torque value and the second compensation ratio.

The measurement device 30 is configured to set a second intermediate value greater than the first intermediate value and less than the limit torque value. The first intermediate value is greater than 0 and less than the second intermediate value. The measurement device 30 defines a third torque range based on the second intermediate value. The second torque range is greater than the first intermediate value and less than the second intermediate value, and the third torque range is greater than the second intermediate value and less than the limit torque value. When the measurement device 30 is in the correction mode and the standard torque value has been input, if the standard torque value is within the third torque range, the measurement device 30 calculates a third compensation ratio based on the measured torque value and the standard torque value, and the third compensation ratio is between 0.5 and 1.5 inclusive. When the measurement device 30 is in the working mode, if the measured torque value is within the third torque range, the compensation torque value displayed on the display 311 is the product of the measured torque value and the third compensation ratio.

The first intermediate value is greater than 0.1 times and less than 0.4 times the limit torque value, and the second intermediate value is greater than 0.5 times and less than 0.8 times the limit torque value.

The mode button 312 is configured to be pressed to cause the display 311 to show a correction interface F, and the correction interface F displays a first parameter P1, which represents the numeric portion of the measured torque value. The setting button 313 is configured to be pressed to cause the correction interface F to display a second parameter P2, which represents the numeric portion of the standard torque value. When the standard torque value is within the first torque range, the first compensation ratio is calculated as the ratio of the standard torque value to the measured torque value. When the standard torque value is within the second torque range, the second compensation ratio is calculated as the ratio of the standard torque value to the measured torque value. When the standard torque value is within the third torque range, the third compensation ratio is calculated as the ratio of the standard torque value to the measured torque value.

The relationship between the first compensation ratio and the measured torque value and the standard torque value can be expressed by Equation 1. The relationship between the second compensation ratio and the measured torque value and the standard torque value can be expressed by Equation 2. The relationship between the third compensation ratio and the measured torque value and the standard torque value can be expressed by Equation 3, where X1, X2, and X3 represent the first compensation ratio, the second compensation ratio, and the third compensation ratio, respectively:

$$[ Equation 1 ] \times 1 = \frac{standard torque value}{measured torque value}$$

where 0<standard torque value<first intermediate value.

$$[ Equation 3 ] \times 3 = \frac{standard torque value}{measured torque value}$$

where first intermediate value<standard torque value<second intermediate value.

$$[ Equation 2 ] \times 2 = \frac{standard torque value}{measured torque value}$$

where second intermediate value<standard torque value<limit torque value.

For example, during practical use, a user may utilize a commercially available torque testing machine to verify the torque tool 10 and obtain the standard torque value (i.e., the second parameter P2). If the limit torque is 200 N·m, the first intermediate value may be set to 40 N·m, and the second intermediate value may be set to 120 N·m.

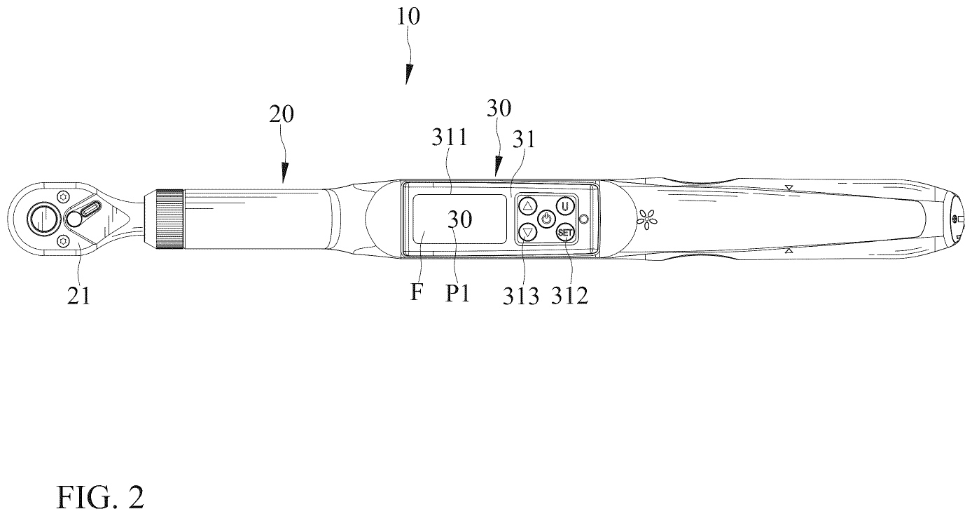

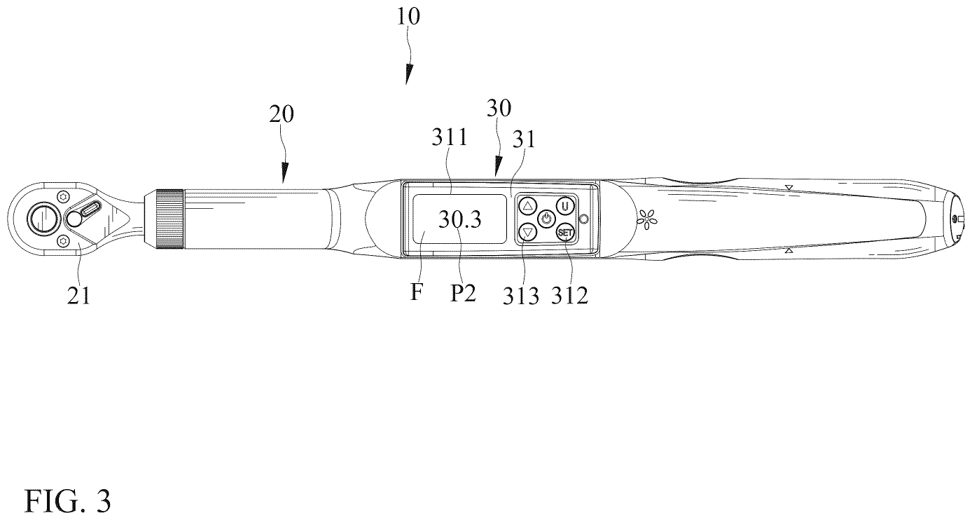

When the measurement device 30 is in the correction mode and the torque tool 10 is used to apply torque to the torque testing machine, if the first parameter P1 displayed is 30 (as shown in FIG. 2) and the second parameter P2 entered by pressing the setting button 313 is 30.3 (as shown in FIG. 3), it indicates that the measured torque value is smaller than the standard torque value with an error of 1%. Since the standard torque value is less than 40 N·m, the measurement device 30 sets the first compensation ratio to 1.01. The display 311 subsequently shows the compensated torque value as the product of the measured torque value and 1.01 when the measured torque value is within the first torque range.

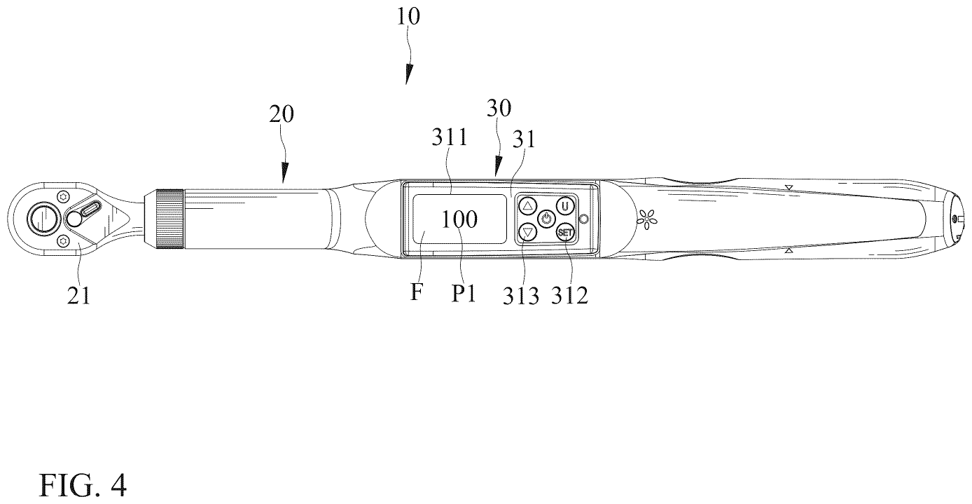

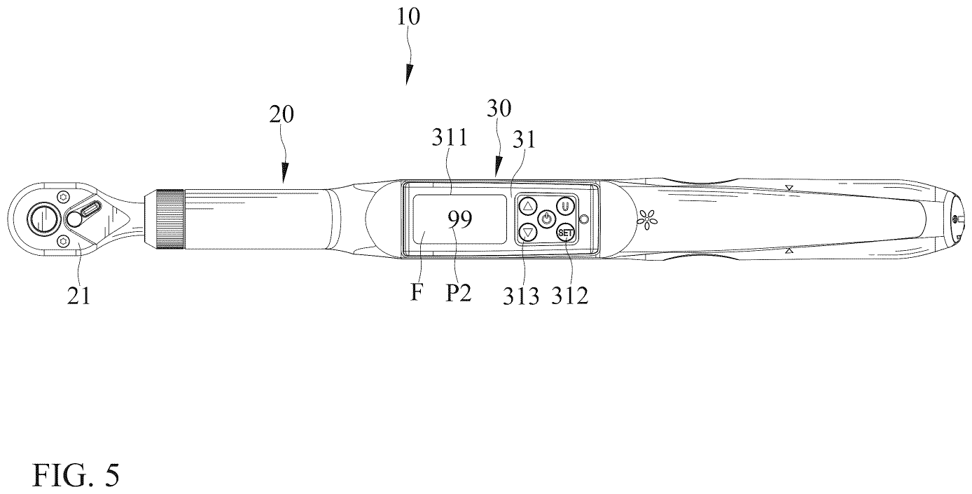

Similarly, if the first parameter P1 displayed is 100 (as shown in FIG. 4) and the second parameter P2 entered by pressing the setting button 313 is 99 (as shown in FIG. 5), it indicates that the measured torque value is greater than the standard torque value with an error of 1%. Since the standard torque value is greater than 40 N·m and less than 120 N·m, the measurement device 30 sets the second compensation ratio to 0.99. The display 311 subsequently shows the compensated torque value as the product of the measured torque value and 0.99 when the measured torque value is within the second torque range.

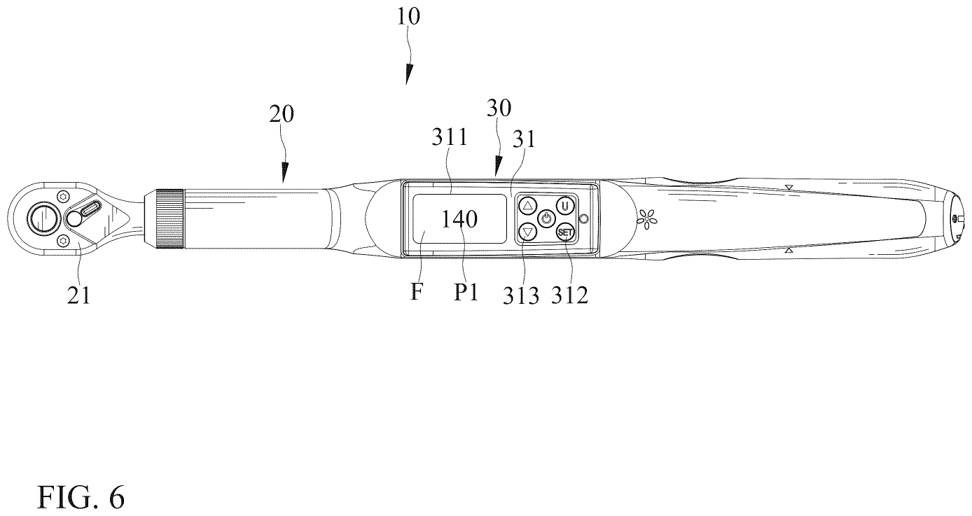

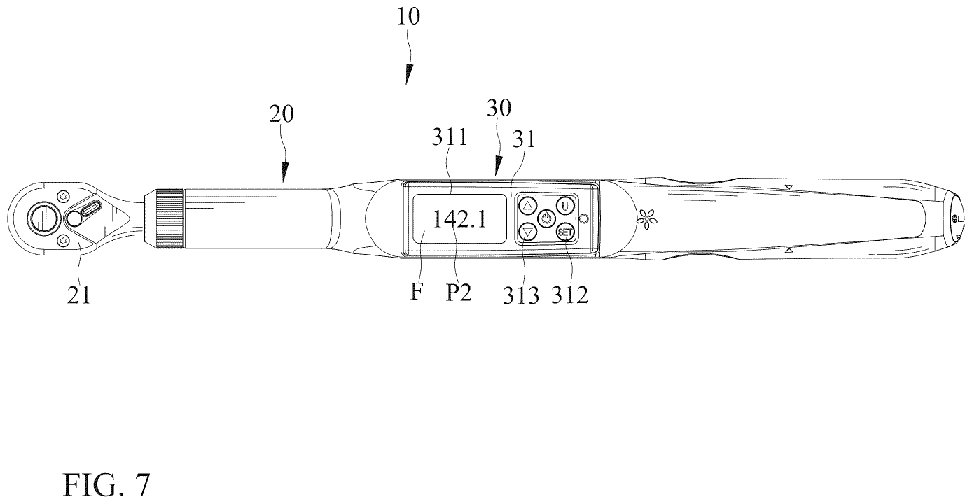

Likewise, If the first parameter P1 displayed is 140 (as shown in FIG. 6) and the second parameter P2 entered by pressing the setting button 313 is 142.1 (as shown in FIG. 7), it indicates that the measured torque value is smaller than the standard torque value with an error of 1.5%. Since the standard torque value is greater than 120 N·m and less than 200 N·m, the measurement device 30 sets the third compensation ratio to 1.015. The display 311 subsequently shows the compensated torque value as the product of the measured torque value and 1.015 when the measured torque value is within the third torque range.

Through the above structure, the torque tool 10 enables onboard calibration and compensation adjustments, allowing the system to automatically calculate the compensation value. Errors can be directly corrected on the torque tool 10 without the need for an external computer or specialized calibration instruments. This functionality enables calibration with any torque testing machine, thereby enhancing the convenience of calibration and compensation adjustments.

Furthermore, as most materials exhibit a nonlinear relationship between applied force and resulting strain, the same applies to the torque tool 10. The output torque value of the torque tool 10 is not linearly related to the strain values detected by strain gauges. To address this, the torque tool 10 provides specific compensation values for different torque ranges based on the torque value, thereby improving the accuracy of the compensated torque value output. This ensures that the compensated torque value closely approximates the actual output torque value.

Although specific embodiments have been illustrated and described, numerous modifications and variations are still possible without departing from the scope of the invention. The scope of the invention is limited by the accompanying claims.

1. A torque tool with automatic compensation value conversion, comprising:
a body having a driving head at one end thereof; and
a measurement device connected to the body and configured to measure the torque of the driving head to obtain a measured torque value, wherein the measurement device has a control panel including a display, a mode button, and a setting button, wherein the mode button is configured to be pressed to switch the measurement device from a working mode to a correction mode and to display the measured torque value on the display, wherein the setting button is configured to be pressed to enable the input of a standard torque value, wherein the measurement device calculates a first compensation ratio based on the measured torque value and the standard torque value, and the first compensation ratio is between 0.5 and 1.5 inclusive;
wherein when the measurement device is in the working mode, the measurement device measures the torque of the driving head and displays a compensation torque value on the display, and the compensation torque value is the product of the measured torque value and the first compensation ratio.

2. The torque tool of claim 1, wherein the measurement device is configured to set a limit torque value based on a rated upper limit torque value withstandable by the driving head, wherein the measurement device is further configured to set a first intermediate value greater than 0 and less than the limit torque value, wherein the measurement device defines a first torque range and a second torque range based on the first intermediate value, wherein the first torque range is greater than 0 and less than the first intermediate value, and the second torque range is greater than the first intermediate value and less than the limit torque value;
wherein when the measurement device is in the correction mode and the standard torque value has been input, if the standard torque value is within the first torque range, the measurement device obtains the first compensation ratio, and If the standard torque value is within the second torque range, the measurement device calculates a second compensation ratio based on the measured torque value and the standard torque value, and the second compensation ratio is between 0.5 and 1.5 inclusive; and
wherein when the measurement device is in the working mode, if the measured torque value is within the first torque range, the compensation torque value displayed on the display is the product of the measured torque value and the first compensation ratio, If the measured torque value is within the second torque range, the compensation torque value displayed on the display is the product of the measured torque value and the second compensation ratio.

3. The torque tool of claim 2, wherein the measurement device is configured to set a second intermediate value greater than the first intermediate value and less than the limit torque value, wherein the first intermediate value is greater than 0 and less than the second intermediate value, wherein the measurement device defines a third torque range based on the second intermediate value, wherein the second torque range is greater than the first intermediate value and less than the second intermediate value, wherein the third torque range is greater than the second intermediate value and less than the limit torque value;
wherein when the measurement device is in the correction mode and the standard torque value has been input, if the standard torque value is within the third torque range, the measurement device calculates a third compensation ratio based on the measured torque value and the standard torque value, and the third compensation ratio is between 0.5 and 1.5 inclusive; and
wherein when the measurement device is in the working mode, if the measured torque value is within the third torque range, the compensation torque value displayed on the display is the product of the measured torque value and the third compensation ratio.

4. The torque tool of claim 3, wherein the first intermediate value is greater than 0.1 times and less than 0.4 times the limit torque value, and the second intermediate value is greater than 0.5 times and less than 0.8 times the limit torque value.

5. The torque tool of claim 3, wherein the mode button is configured to be pressed to cause the display to show a correction interface, wherein the correction interface displays a first parameter, which represents the numeric portion of the measured torque value, wherein the setting button is configured to be pressed to cause the correction interface to display a second parameter, which represents the numeric portion of the standard torque value;
wherein when the standard torque value is within the first torque range, the first compensation ratio is calculated as the ratio of the standard torque value to the measured torque value;
wherein when the standard torque value is within the second torque range, the second compensation ratio is calculated as the ratio of the standard torque value to the measured torque value; and
wherein when the standard torque value is within the third torque range, the third compensation ratio is calculated as the ratio of the standard torque value to the measured torque value.
